(19) United States
(12) Patent Application Publication
(10) Pub. No.: US 2014/0137416 A1
(43) Pub. Date: May 22, 2014

(54) Cutting Blade Cutting Device

(71) Applicant: Horvath Iosif Robert, New Westminster (CA)

(72) Inventor: Horvath Iosif Robert, New Westminster (CA)

(21) Appl. No.: 14/087,321

(22) Filed: Nov. 22, 2013

Related U.S. Application Data
(60) Provisional application No. 61/729,338, filed on Nov. 22, 2012.

(51) Int. Cl. B26D 5/08; B26B 27/00

(52) U.S. Cl. CPC B26D 5/08; B26B 27/00
USPC 30/275.4

(57) ABSTRACT

A cutting tool for removing and adhesive joint for a window may include an anchor assembly to be anchored on a support surface, a pulling assembly including a cutting blade to cut the adhesive joint and a cord to move the pulling assembly towards the anchor assembly.

### PRIORITY

The present invention claims priority under 35 USC section 119 based on a provisional application 61/729,338 which was filed on Nov. 22, 2012.

### FIELD OF THE INVENTION

The present invention relates generally to cutting tools, and in particular to a tool and method for separating a vehicle glazing seam.

### BACKGROUND

Fixed vehicle glazing, especially automobile windshields and rear windows, is typically secured in place with bonding or gasket material forming a bead or seam between the glazing and the vehicle body. Exemplary bonding materials include rubber, urethane, epoxy, silicone, etc. The bonding material generally forms a seam between a perimeter of the glazing and a frame (sometimes referred to as a “fence”) defined by the vehicle body.

Glazing sometimes has to be removed for replacement, salvage or resealing. It may be acceptable to destroy damaged glazing in the process of removing it for replacement, but for salvage and resealing operations the glazing must be removed intact and undamaged. Removal of glazing generally requires separation of its bonding material seam.

A variety of devices and methods have heretofore been proposed for separating vehicle glazing seams. For example, the Barber U.S. Pat. No. 4,080,734 discloses a method and percussion tool for removing a vehicle windshield. The tool includes wing portions with blades projecting therefrom to define L-shaped cutting edges for separating a bonding material seam. A pneumatic tool holder or a hammer provides blows for advancing the Barber tool, but the blows can damage the glazing. Seam cutting devices driven by reciprocating power tools are disclosed in the Edwards U.S. Pat. No. 3,924,327 and the Lock U.S. Pat. No. 4,395,825.

It has also been proposed to mount blades specially designed for separating bonding material on oscillating power tools. For examples, see the Morford et al. U.S. Pat. No. 4,215,475 and the Grunikiewicz et al. U.S. Pat. No. 4,543,720. The Morford et al. tool includes a handle mounted on a cable for pulling the tool around the perimeter of a glazing pane to be removed.

Other prior art devices include heated blades, or “hot knives”, for melting the bonding material of the glazing seam. Such tools are available from the Pittsburg Plate Glass Company (PPG) in Pittsburg, Pa. under the trademark SWIV-L-CUT. Although a cutting tool hot enough to melt the bonding material can facilitate removal of the glazing pane, damage to the vehicle can result from scorching. Also, the different melting temperatures of various bonding materials tend to limit the usefulness of particular hot knives to only the bonding materials that they were designed for.

Yet another technique for removing glazing panels involves stringing a thin wire through the bonding material seam and pulling it around the perimeter of the glazing. This procedure generally requires two workers to guide and pull the wire, one on the inside of the vehicle and the other on the outside. Fixed vehicle glazing, especially automobile windshields and rear windows, is typically secured in place with bonding or gasket material forming a bead or seam between the glazing and the vehicle body. Exemplary bonding materials include rubber, urethane, epoxy, silicone, etc. The bonding material generally forms a seam between a perimeter of the glazing and a frame (sometimes referred to as a “fence”) defined by the vehicle body.

Glazing sometimes has to be removed for replacement, salvage or resealing. It may be acceptable to destroy damaged glazing in the process of removing it for replacement, but for salvage and resealing operations the glazing must be removed intact and undamaged. Removal of glazing generally requires separation of its bonding material seam.

A variety of devices and methods have heretofore been proposed for separating vehicle glazing seams. For example, the Barber U.S. Pat. No. 4,080,734 discloses a method and percussion tool for removing a vehicle windshield. The tool includes wing portions with blades projecting therefrom to define L-shaped cutting edges for separating a bonding material seam. A pneumatic tool holder or a hammer provides blows for advancing the Barber tool, but the blows can damage the glazing. Seam cutting devices driven by reciprocating power tools are disclosed in the Edwards U.S. Pat. No. 3,924,327 and the Lock U.S. Pat. No. 4,395,825.

It has also been proposed to mount blades specially designed for separating bonding material on oscillating power tools. For examples, see the Morford et al. U.S. Pat. No. 4,215,475 and the Grunikiewicz et al. U.S. Pat. No. 4,543,720. The Morford et al. tool includes a handle mounted on a cable for pulling the tool around the perimeter of a glazing pane to be removed.

Other prior art devices include heated blades, or “hot knives”, for melting the bonding material of the glazing seam. Such tools are available from the Pittsburg Plate Glass Company (PPG) in Pittsburg, Pa. under the trademark SWIV-L-CUT. Although a cutting tool hot enough to melt the bonding material can facilitate removal of the glazing pane, damage to the vehicle can result from scorching. Also, the different melting temperatures of various bonding materials tend to limit the usefulness of particular hot knives to only the bonding materials that they were designed for.

Yet another technique for removing glazing panels involves stringing a thin wire through the bonding material seam and pulling it around the perimeter of the glazing. This procedure generally requires two workers to guide and pull the wire, one on the inside of the vehicle and the other on the outside.

U.S. Pat. No. 4,819,531 discloses a cutting tool including such as a blade assembly with a blade mounted on a handle. A winch assembly is connected to the blade assembly and includes a cable wound on a drum. The drum is advanced by a drive ratchet subassembly and is connected at its free end to a hook. A method of separating a seam with the cutting tool includes the steps of anchoring the cable, inserting the blade in the seam and retracting the cable with respect to the blade whereby the blade is advanced through the seam.

### SUMMARY

A cutting tool for removing and adhesive joint for a window may include an anchor assembly to be anchored on a support surface, a pulling assembly including a cutting blade to cut the adhesive joint and a cord to move the pulling assembly towards the anchor assembly.

The anchor assembly may be detachably connected to a support surface.

The anchor assembly may include a L-shaped plate.

The anchor assembly may include double-sided tape to detachably connect to the support surface.

The anchor assembly may include a suction cup to detachably connect to the support surface.

The pulley assembly may include a cutting blade which is removable.

The pulley assembly may adjust the distance between the cutting blade and the main body of the pulley assembly.

The pulley assembly may include a winch to engage a cord which is connected to the anchor assembly.

The winch may be positioned between a pair of opposing arms.

The pulley assembly may include a blade holder and a main body to secure the cutting blade in a slot defined by the blade holder and the main body.

### BRIEF DESCRIPTION OF THE DRAWINGS

The invention may be understood by reference to the following description taken in conjunction with the accompanying drawings, in which, like reference numerals identify like elements, and in which:

FIG. 1 is a view of the invention including a pulling assembly and an anchor assembly;

FIG. 2 is a view of the invention including a pulling assembly showing the cutting blade adjustment and securing apparatus;

FIG. 3 is an exploded view of the invention including a pulling assembly;

FIG. 4 is a view of the invention including a pulling assembly connected to a cordless drill;

FIG. 5 is a view of the invention including a pulling assembly connected to the anchor assembly;

FIGS. 6, 7, 8 is a schematic view of the invention in a removal process of the auto glass panel;

FIG. 9 is a schematic view of the invention in the removal process on the bonded building glass panel or a bonded modular building façade.

### DETAILED DESCRIPTION

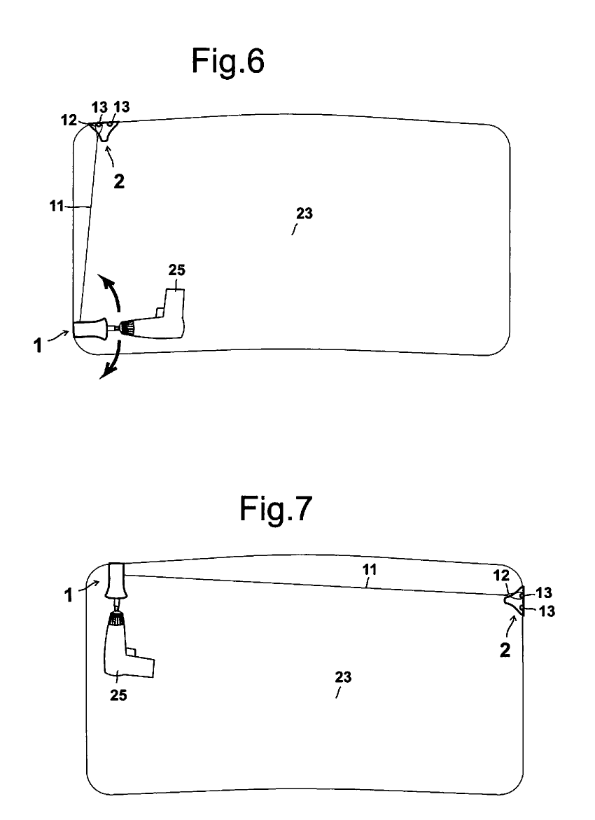

The present invention reduces the potential for injury to the technician/user of the present invention. The present invention reduces the physical effort to operate the present invention for the technician. The present invention reduces the damage which may occur to the vehicle and provides a controlled removal process with a one hand using the handle of the pulling device by providing direction as shown in FIG. 5. The present invention allows for the remaining hand to be used to wind up the cord and to control the pulling device as shown in FIG. 6. The present invention provides for easy blade replacement and provides for easy blade adjustment for different operating heights.

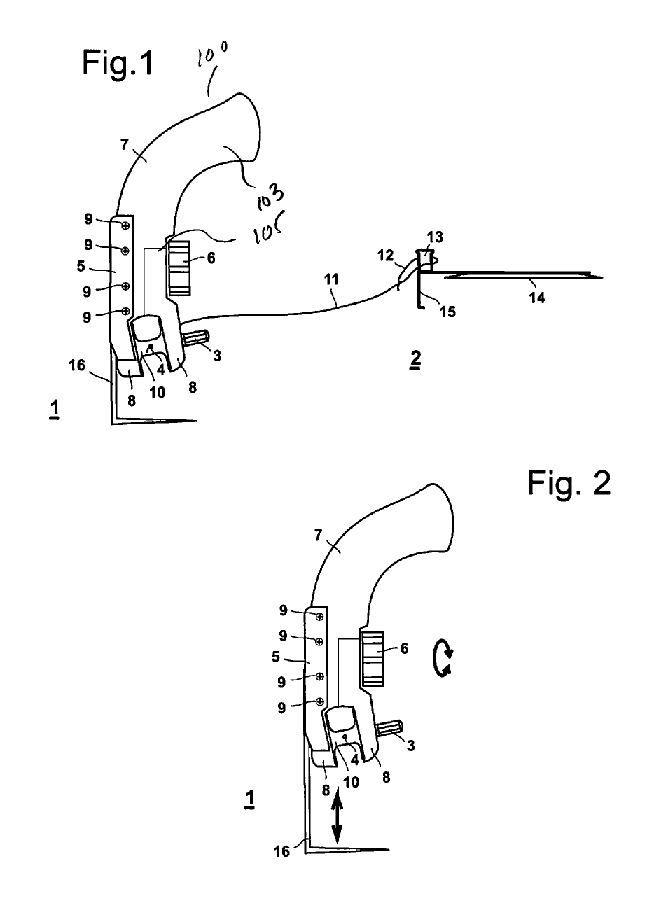

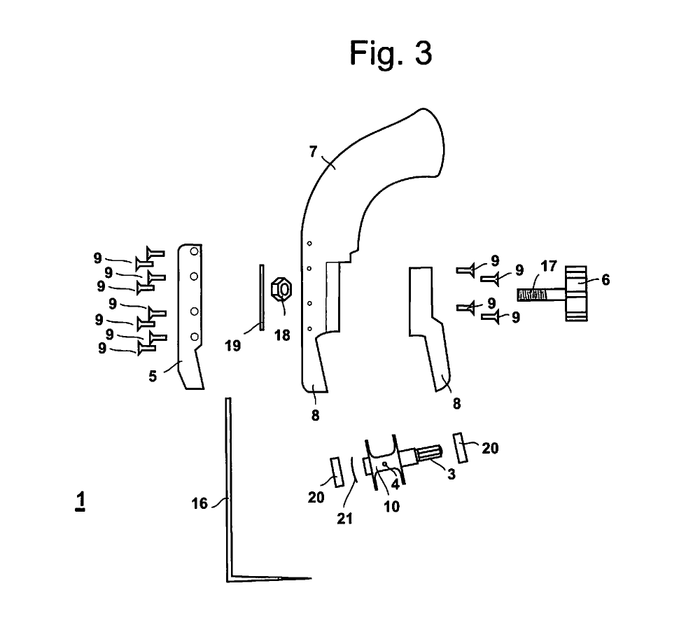

As shown in FIG. 1, the present invention may include a cutting tool 100 which may include the pulling assembly labeled with reference number 1 and the anchor assembly labeled with reference number 2. The pulling assembly 1 may include the main body 7 which may include a handle 103 which may be opposed to the cutting blade 16, two parallel arms 8 which may extend from the center portion 105 adjacent to the cutting blade 16. The drum/winch 10 may extend between the two parallel arms 8. The winch 10 may engage the cord 11 and may be attached to the cord 11 at the attaching hole 4. The cord 11 may engage the connecting head 3 which may be an universal ¼ inch hexagonal connecting head 3. The winch 10 may be connected to the parallel arms 8 with two ball bearings or bushings 20 as illustrated in FIG. 3. A spring washer 21 as illustrated in FIG. 3 may be positioned between the bearing 20 and the winch 10 to prevent an uncontrolled or excessive rotation to the winch 10.

At the center portion 105 of the main body 7 on the opposite side of the winch 10 is the cutting blade holder 5 which may be attached with fasteners such as screws 9. The securing knob 6 it is located on the center portion 105, opposed to the cutting blade holder 5.

The fasteners such as nut 18 and plate 19 as illustrated in FIG. 3 and positioned on the center portion 105 between the main body 7 and the cutting blade 16 for fastening and securing the cutting blade 16.

The cutting blade 16 engages a slot formed in the between the main body 7 and the cutting blade holder 5 by being inserted into the slot between the main body 7 and the cutting blade holder 5.

By turning the knob six as shown in FIG. 2, the cutting blade 16 can be secured, removed or adjusted in position with respect to the cutting blade 16. The distance between the cutting blade 16 and the main body 7 can be varied by loosening and tightening the knob 6.

The anchor assembly 2 further includes a plate 15 (which may be L-shaped) which may form a downward extending hook and one or two anchor pins 13 which may extend upwards. The plate 15 may cooperate with a fastener such as a small diameter suction cup or double side tape 14 for detachably holding the anchor assembly 2 in place on a support surface during the removal process of the glass.

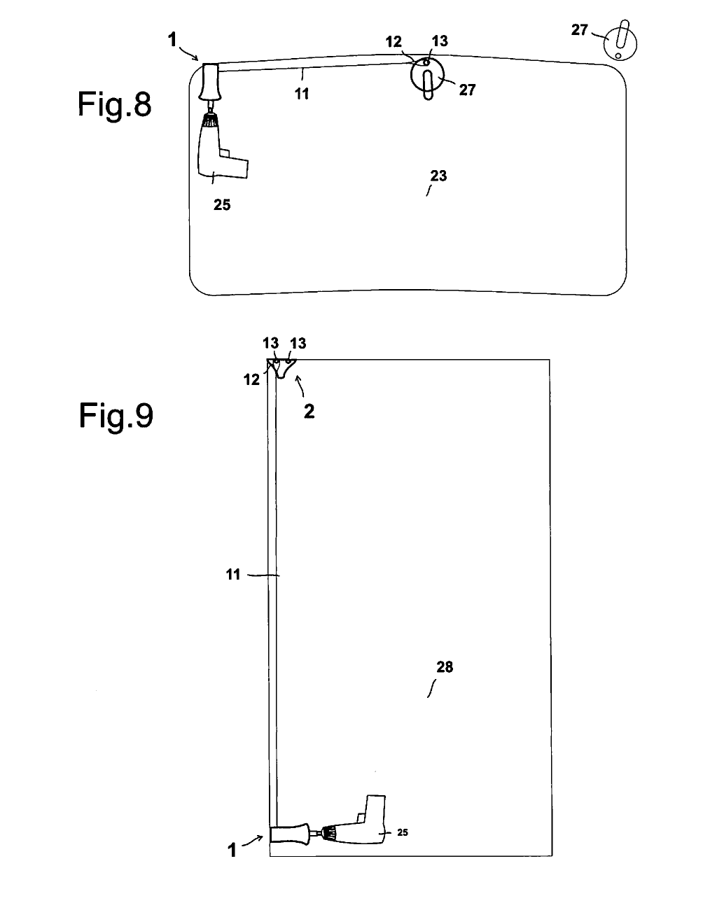

The anchor assembly 2 may be hooked and to the panel edge 23 or other support surface edge and serves as an anchor point for the pulling assembly 1. For the anchor point embodiment, the anchor assembly 2 can also be use a suction cup 27, which can accommodate one anchor pin 13. The anchor suction cup 27 can be placed on the different elements (different support surfaces) then the removable panel as shown in FIG. 8.

The pulling assembly 1 may be connected with a cord 11 to the anchor assembly 2. The first end of the cord 11 may be connected to the drum/winch 10 using the attaching hole 4, the second end of the cord which by forming a loop 12 may be attached to the anchor pin 13 as shown in FIG. 5

The cord 11 may be formed from a material having sufficient tear resistance such as Spectra, Dyneema or Nylon cord or other appropriate material. The main body 7 may be formed preferable of plastic, metal or aluminum or other appropriate material.

The cutting blade holder 5 may be formed of steel or other appropriate material.

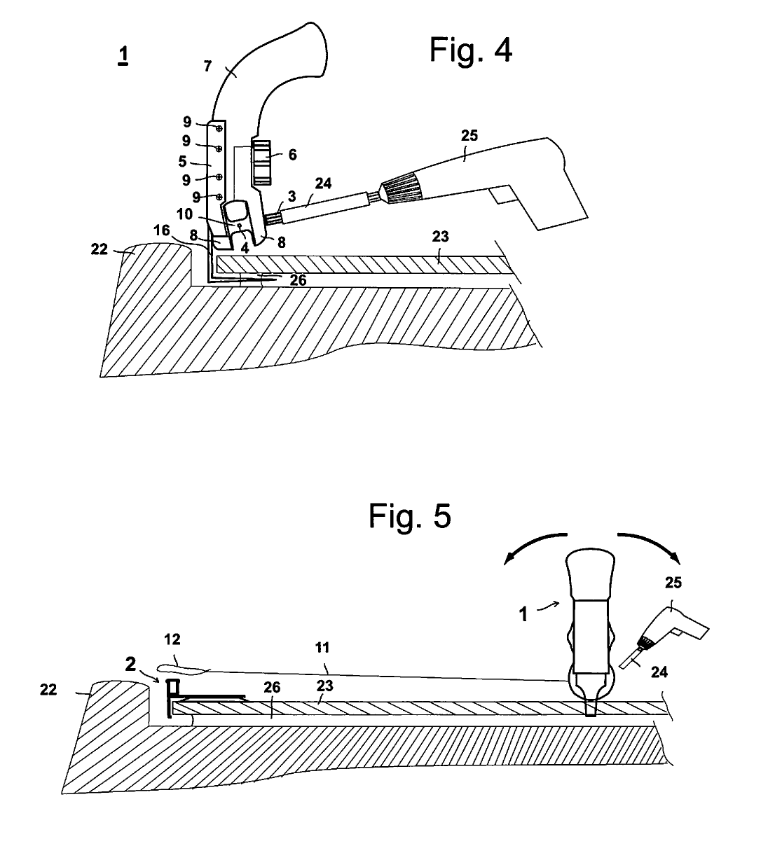

In FIG. 4 shows the pulling assembly 1 with the cutting blade 16 pierced through the adhesive 26 and the cordless drill 25 may engage the connecting head 3 with an extended bit holder 24.

The cordless drill 25 may wind-up the cord 11 on the winch 10, moving the cutting blade 16 through the adhesive 26, and also avoiding the pulling assembly 1 from twisting during the cutting process of the adhesive 26. By winding the cord 11 on the winch 10, the cutting blade 16 advances/moves in the adhesive 26 by cutting it.

By removing the cordless drill 25 from the connecting head 3, the movable anchor assembly 2 may be relocated to the next anchor position which may be close to the corner. The movable pulling assembly 1 may be controlled by operator in following handling directions shown in FIGS. 5 and 6.

The removal process and apparatus can be performed in both directions.

FIG. 9 shows the removal process and apparatus being used on a bonded building glass panel or modular façade.

While the invention is susceptible to various modifications and alternative forms, specific embodiments thereof have been shown by way of example in the drawings and are herein described in detail. It should be understood, however, that the description herein of specific embodiments is not intended to limit the invention to the particular forms disclosed.

1) A cutting tool for removing an adhesive joint for a window, comprising:
an anchor assembly to be anchored on a support surface;
a pulling assembly including a cutting blade to cut the adhesive joint;
a cord to move the pulling assembly towards the anchor assembly.

2) A cutting tool for removing an adhesive joint for a window as in claim 1, wherein the anchor assembly is detachably connected to a support surface.

3) A cutting tool for removing an adhesive joint for a window as in claim 1, wherein the anchor assembly includes a L-shaped plate.

4) A cutting tool for removing an adhesive joint for a window as in claim 1, wherein the anchor assembly includes double-sided tape to detachably connect to the support surface.

5) A cutting tool for removing an adhesive joint for a window as in claim 1, wherein the anchor assembly includes a suction cup to detachably connect to the support surface.

6) A cutting tool for removing an adhesive joint for a window as in claim 1, wherein the pulley assembly includes a cutting blade which is removable.

7) A cutting tool for removing an adhesive joint for a window as in claim 1, wherein the pulley assembly adjust the distance between the cutting blade and the main body of the pulley assembly.

8) A cutting tool for removing an adhesive joint for a window as in claim 1, wherein the pulley assembly includes a winch to engage a cord which is connected to the anchor assembly.

9) A cutting tool for removing an adhesive joint for a window as in claim 8, wherein the winch is positioned between a pair of opposing arms.

10) A cutting tool for removing an adhesive joint for a window as in claim 1, wherein the pulley assembly includes a blade holder and a main body to secure the cutting blade in a slot defined by the blade holder and the main body.
